(19) United States
(12) Patent Application Publication
(10) Pub. No.: US 2011/0145323 A1
(43) Pub. Date: Jun. 16, 2011

(54) METHOD AND APPARATUS FOR CONTROLLING DELIVERY OF SERVICES TO USER DEVICES

(76) Inventors: Colin Kahn, Morris Plains, NJ (US); Anil Sawkar, Basking Ridge, NJ (US)

(21) Appl. No.: 12/639,135

(22) Filed: Dec. 16, 2009

(51) Int. Cl. G06F 15/16

(52) U.S. Cl. 709/203; 709/224

(57) ABSTRACT

A capability is provided for controlling delivery of services from a server to a user device using a service delivery control function. A method for controlling delivery of services from a server to a user device includes receiving service delivery feedback information from the user device and initiating, based on at least a portion of the service delivery feedback information, a control action adapted for controlling at least one characteristic of delivery of the service from the server to the user device. The service delivery feedback information includes user device state information associated with the user device and user activity information indicative of activity of a user using the user device. The at least one characteristic of delivery of the service includes one or more of a timing with which the service is provided to the user device, selection of services, service features, and/or content to be delivered as part of service delivery, one or more rates associated with service delivery, and the like, as well as combinations thereof.

### FIELD OF THE INVENTION

The invention relates generally to communication networks and, more specifically but not exclusively, to controlling the delivery of services to user devices via communications networks.

### BACKGROUND

A common goal in both wireline networks and wireless networks is to provide good quality of service (QoS) to users accessing services via such networks. To this end, existing wireline and wireless technologies have well-developed, standardized mechanisms for providing satisfactory QoS to users. These mechanisms typically operate to ensure that parameters associated with packet transport are optimized. For example, QoS parameters (e.g., such as minimum guaranteed bit rate, maximum delay, and timing jitter limits) may be specified for bearers within such networks. In many cases, these parameters are tailored to the specific class of applications being transported by the bearers (e.g., classes such as best effort, conversational voice, and streaming). Additionally, network protocols (e.g., such as Transmission Control Protocol (TCP) congestion control and Explicit Congestion Notification (ECN) feedback) allow rates to be adapted to time varying constraints of the network. Disadvantageously, however, despite the improvements in QoS that may be achieved by using these mechanisms, these mechanisms still fail to provide satisfactory quality-of-experience (QoE) to users, due to other factors not addressed by such mechanisms.

### SUMMARY

Various deficiencies in the prior art are addressed by embodiments for controlling delivery of services from a server to a user device using a service delivery control function. In one embodiment, a method for controlling delivery of services from a server to a user device using the service delivery control function includes receiving service delivery feedback information from the user device and initiating, based on at least a portion of the service delivery feedback information, a control action adapted for controlling at least one characteristic of delivery of the service from the server to the user device. The service delivery feedback information includes user device state information associated with the user device and user activity information indicative of activity of a user using the user device. The control of the at least one characteristic of delivery of the service includes one or more of controlling a timing with which the service is provided to the user device, controlling selection of services, service features, and/or content to be delivered as part of service delivery, controlling one or more rates associated with service delivery, controlling adaptation of services, service features, and/or content to be delivered as part of service delivery, and the like, as well as combinations thereof.

### BRIEF DESCRIPTION OF THE DRAWINGS

The teachings herein can be readily understood by considering the following detailed description in conjunction with the accompanying drawings, in which:

FIG. 1 depicts a high-level block diagram of a communication system for supporting control of delivery of services to a user device;

FIG. 2 depicts one embodiment of a method for controlling delivery of services from a server to a user device; and

FIG. 3 depicts a high-level block diagram of a computer suitable for use in performing the functions described herein.

To facilitate understanding, identical reference numerals have been used, where possible, to designate identical elements that are common to the figures.

### DETAILED DESCRIPTION OF THE INVENTION

A service delivery control capability is depicted and described herein. The service delivery control capability improves delivery of services to a user device of a user. The service delivery control capability supports feedback of service delivery feedback information from the user device to a service delivery control function that is configured for using the service delivery feedback information from the user device for controlling delivery of services to the user device. The service delivery feedback information includes at least one of user device state information and user activity information. The service delivery control capability enables control over one or more characteristics of delivery of the service to the user device, In this manner, the service delivery capability reduces or even prevents the user dissatisfaction that typically results when application layer activity on a user device collides with one or both of user activity on the user device and the current status of the user device, thereby providing an enhanced quality of experience (QoE) for the user of the user device.

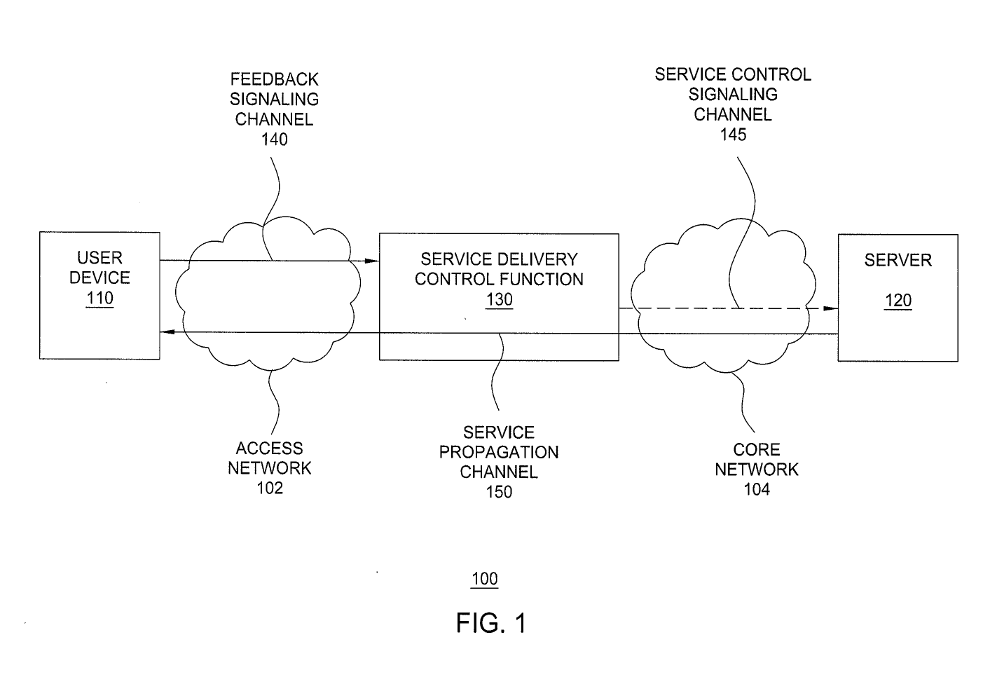

FIG. 1 depicts a high-level block diagram of a communication system for supporting control of delivery of services from a server to a user device.

The communication system 100 includes a user device (UD) 110 and a server 120, where the UD 110 is adapted for receiving services provided by server 120 and the server 120 is adapted for providing services to UD 110, and, further, where delivery of services from the server 120 to the UD 110 is controlled by a service delivery control function (SDCF) 130 based on service delivery feedback information propagated from the UD 110 to the SDCF 130.

The communication system 100 includes an access network (AN) 102 for facilitating communications between UD 110 and SDCF 130 and a core network (CN) 104 for facilitating communications between server 120 and SDCF 130. It will be appreciated that the arrangement of AN 102 and CN 104 with respect to SDCF 130 is presented for illustrative purposes only since SDCF 130 may be implemented within communication system 100 in many ways (e.g., SDCF 130 may be deployed within AN 102, within CN 104, in any other suitable location(s) within communication system 100, and the like, as well as combinations thereof).

The communication system 100 may be implemented using any suitable underlying communication technology, which may include wireline communication technology and/or wireless communication technology.

In an embodiment in which the communication system 100 is implemented using wireless communication technology, communication within communication system 100 may be supported using any suitable wireless technology, such as Global System for Mobile (GSM), Code Division Multiple Access (CDMA), Universal Mobile Telecommunication System (UMTS), Long Term Evolution (LTE), Worldwide Interoperability for Microwave Access (WiMAX), and the like. For example, AN 102 may be implemented as a CDMA Evolution-Data Optimized (EVDO) radio access network and CN 104 may be implemented as an Evolved Packet Core (EPC) and/or a 3GPP2 core network. For example, AN 102 may be implemented as an LTE access network and CN 104 may be implemented as an EPC. In other words, the service delivery control capability is not limited to any particular generation of wireless network (e.g., 3G, 4G, or other generations) or to any particular type of wireless network (including any particular type of radio access network or any particular type of core network associated with the radio access network).

In an embodiment in which communication system 100 is implemented using wireline technology, communication within communication system 100 may be provided using any suitable wireline technology, such as Ethernet, cable, and the like.

It will be appreciated that combinations of wireless and wireline communication technologies may be employed for providing services to user devices and, thus, that the service delivery control capability may be provided within any communication network that is suitable for delivering services from servers to user devices.

The UD 110 is a user device suitable for use with the service delivery control capability. The UD 110 is capable of receiving and using services from servers and capable of providing service delivery control information to a service delivery control function adapted for controlling delivery of the services to the user device. For example, the UD 110 may be a user device such as a desktop computer, a laptop computer, a mobile phone, a personal digital assistant (PDA), or any other suitable user device.

The UD 110 includes one or more user interfaces by which services may be presented at UD 110 (e.g., display screens, speakers, and the like) and one or more user interfaces by which the user may control UD 110 (e.g., keypads, touch screens, microphones, and the like) for performing functions such as requesting services from server 120, executing received services at UD 110, interacting with received services at UD 110, and the like, as well as combinations thereof.

The UD 110 supports upstream communication by which UD 110 may transmit information such as service requests, control information (e.g., service delivery feedback information and other types of control information), and the like, as well as combinations thereof. The UD 110 supports downstream communication by which UD 110 may receive services from server 120. The UD 110 may support wireline and/or wireless communication capabilities.

The UD 110 provides service delivery feedback information to SDCF 130.

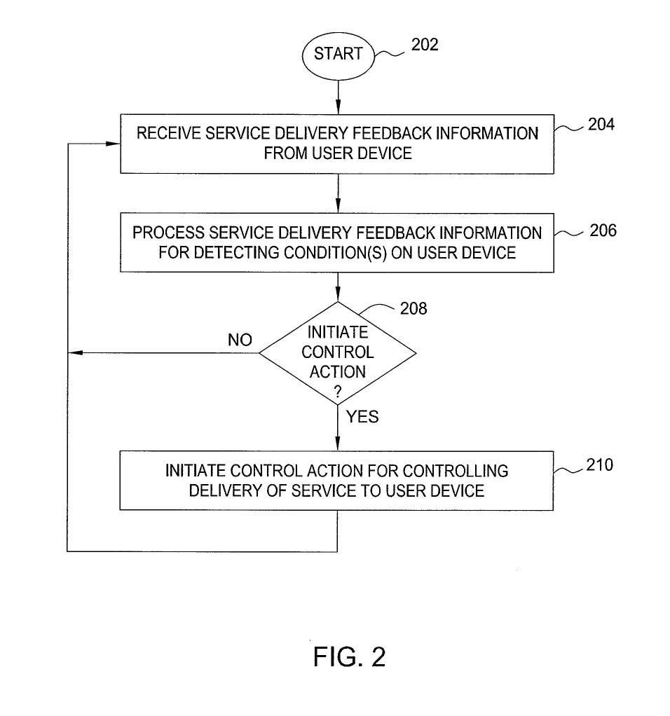

The service delivery feedback information may include any information suitable for use by SDCF 130 in controlling delivery of services provided from the server 120 to the UD 110. The service delivery feedback information that is provided may depend on factors such as the type of service being provided, the type of user device from which the service delivery feedback information is provided, user preferences of one or more users of UD 110, and the like, as well as combinations thereof. In one embodiment, service delivery feedback information includes at least one of user device state information, user activity information, and the like, as well as combinations thereof. A detailed description of the service delivery feedback information and the manner in which service delivery feedback information may be used to control delivery of services is provided herein with respect to FIG. 2.

The UD 110 may provide service delivery feedback information to SDCF 130 in any suitable manner.

The UD 110 may provide service delivery feedback information to SDCF 130 using a feedback signaling channel established between UD 110 and SDCF 130 (illustratively, feedback signaling channel 140).

The feedback signaling channel 140 may be any channel suitable for use in propagating service delivery feedback information from UD 110 to SDCF 130, which may depend on one or more factors, such as the type of underlying technology of the communication system 100, the manner in which SDCF 130 is deployed within communication system 100, and the like.

The feedback signaling channel 140 may be established in any suitable manner (e.g., initiated by the UD 110 or SDCF 130, initiated at any suitable time, and the like). For example, the feedback signaling channel 140 may be initiated by the UD 110 after being powered on, in response to a request by a user of the UD 110, and the like. For example, the feedback signaling channel 140 may be initiated by SDCF 130 in response to detecting or being notified of the presence of UD 110 in the network (e.g., for receiving service delivery control information sufficient for use by SDCF 130 in controlling any services provided to UD 110 while UD 110 is active), in response to a determination that a service should be initiated at the current time (e.g., for receiving service delivery control information sufficient for use by SDCF 130 in determining one or more characteristics by which the service is to be delivered to UD 110), in response to a determination that a service is scheduled to be initiated in the future (e.g., for receiving service delivery control information sufficient for use by SDCF 130 in determining one or more characteristics by which the service is to be delivered to UD 110), and the like, as well as combinations thereof.

The UD 110 may provide service delivery feedback information to SDCF 130 using any suitable timing for providing service delivery feedback information to SDCF 130. For example, UD 110 may transmit service delivery feedback information to SDCF 130 periodically (e.g., in fixed intervals, in response to periodic requests, and the like), responsively (e.g., in response to detecting conditions locally at UD 110, in response to requests from one or more network components, and the like), and the like, as well as combinations thereof.

The UD 110 may provide service delivery feedback information to SDCF 130 in any suitable format, which may depend on factors such as the manner in which feedback signaling channel 140 is implemented, the type of service delivery feedback information being provided, and the like, as well as combinations thereof.

The UD 110 may collect the service delivery feedback information at UD 110 in any suitable manner, which may depend on the type of service delivery feedback information to be collected by UD 110 for transmission to SDCF 130.

In one embodiment, UD 110 may collect at least a portion of the service delivery feedback information using application software running on the UD 110. In this case, application software running on UD 110 is adapted for monitoring conditions on UD 110 for determining service delivery feedback information to be sent to SDCF 130. In one embodiment, application software on the UD 110 may be used to monitor the status of UD 110 for detecting one or more conditions on UD 110. For example, application software on the UD 110 may be used to monitor one or more processes, components, functions, and like elements on UD 110 (e.g., monitoring one or more of a user device power state, a processor of the user device, a memory of the user device, user activity on the user device, and the like) for detecting one or more conditions on UD 110 (e.g., conditions associated with one or more of user device power state, user device processor state, user device memory state, user device battery state, user activity information, and the like, as well as combinations thereof). The manner in which application software on UD 110 may be used to collect service delivery feedback information from UD 110 may be better understood by considering descriptions of the service delivery feedback information that are provided herein. In one such embodiment, SDCF 130 may process at least a portion of the service delivery feedback information using associated application software running on SDCF 130. In this case, application software on SDCF 130 is adapted for processing the service delivery feedback information received from UD 110 for controlling delivery of services to UD 110. In one such embodiment, in which the service delivery control capability is provided using application software running on UD 110 and SDCF 130, feedback signaling channel 140 may be implemented as an application-layer feedback signaling channel that is established between application software running on UD 110 and application software running on SDCF 130.

The server 120 hosts one or more services which may be provided to UD 110. The services include any services which may be supported by the server 120 and utilized by UD 110. For example, the services provided by server 120 to UD 110 may include services such as providing content to UD 110 (e.g., downloading content to UD 110, streaming content to UD 110, and other similar services in which content is provided), executing one or more actions or functions on UD 110 (e.g., executing an automatic backup service on UD 110, executing an automatic software update service on UD 110, and other like services which may involve execution actions or functions on UD 110), and the like, as well as combinations thereof.

The server 120 provides services to the UD 110. The server 120 may provide services to the UD 110 in any suitable manner. The server 120 may provide services to UD 110 using a service propagation channel 150 that is established between the server 120 and the UD 110 (illustratively, service propagation channel 150). The service propagation channel may be any channel suitable for use in providing services from server 120 to UD 110. The server 120 may provide services to UD 110 in response to any suitable trigger condition. For example, server 120 may provide service to UD 110 in response to requests initiated from and/or by UD 110, in response to requests initiated from within the network (e.g., push-type services), via scheduling-based triggering, and the like, as well as combinations thereof. The server 120 may provide services to UD 110 in any suitable format. The manner in which the server 120 provides services to the UD 110 (e.g., such as the implementation of the service propagation channel 150, the trigger conditions, the service format, and the like) may depend on one or more factors. For example, the manner in which server 120 provides services to UD 110 may depend on the network implementation of the network over which the service is provided (e.g., such as the type of network over which the service is provided, the manner in which the SDCF 130 is implemented within the network, and the like, as well as combinations thereof). For example, the manner in which server 120 provides services to UD 110 may depend on the type of service being provided, e.g., such as providing content from server 120 to UD 110 (e.g., where the content is stored on the server 120), causing content to be provided to UD 110 (e.g., where the content is not stored on the server 120 and server 120 initiates control signaling to one or more other network elements for causing the content to be provided to UD 110), accessing the UD 110 remotely to control or perform one or more functions on UD 110, and the like. For example, the manner in which server 120 provides services to UD 110 may depend on other factors, such as the quality of the service being provided, the quality-of-service with which the service is provided, and the like, as well as combinations thereof.

The SDCF 130 provides service delivery control functions adapted for controlling delivery of services from server 120 to UD 110 based on service delivery feedback information received from UD 110.

The SDCF 130 receives service delivery feedback information from UD 110. The SDCF 130 may receive service delivery feedback information from UD 110 in any suitable manner, which may include any suitable manner that is consistent with the description of the manner in which UD 110 may provide service delivery feedback information to SDCF 130.

The SDCF 130 processes the service delivery feedback information for use in controlling delivery of services from server 120 to UD 110. The SDCF 130 may process the service delivery feedback information in any suitable manner, which may depend on factors such as the type of service delivery feedback information received from UD 110, the type of service to be controlled by SDCF 130, the manner in which the service is to be controlled by SDCF 130, and the like, as well as combinations thereof.

In one embodiment, SDCF 130 may process at least a portion of the service delivery feedback information using application software running on SDCF 130. In this case, application software running on SDCF 130 is adapted for receiving service delivery feedback information and using the service delivery feedback information for controlling delivery of services from server 120 to UD 110. For example, application software running on SDCF 130 is adapted for monitoring for detection of conditions based on the service delivery feedback information in order to provide proper control over services that are provided from server 120 to UD 110 (e.g., monitoring for conditions associated with the power state of UD 110, the processor state of UD 110, the memory state of UD 110, the battery state of UD 110, user activity on UD 110, and the like, as well as combinations thereof). The manner in which application software on SDCF 130 may be used to process service delivery feedback information for controlling delivery of services from server 120 to UD 110 may be better understood by considering descriptions of the service delivery feedback information that are provided herein. In one such embodiment, UD 110 may collect at least a portion of the service delivery feedback information using associated application software running on UD 110. In one such embodiment, in which the service delivery control capability is provided using application software running on UD 110 and SDCF 130, the feedback signaling channel 140 may be implemented as an application-layer feedback signaling channel established between application software running on UD 110 and application software running on SDCF 130.

As depicted in FIG. 1, SDCF 130 may control delivery of service from server 120 to UD 110 directly and/or indirectly.

In one embodiment, the service propagation channel 150 is established such that it traverses SDCF 130 (illustrated in FIG. 1), thereby enabling SDCF 130 to provide direct control over delivery of services from server 120 to UD 110 (e.g., caching content received from server 120 on behalf of UD 110 for later delivery of content to UD 110 at a more suitable time, performing rate adaptation of content being propagated from server 120 to UD 110 performing content adaptation of content being propagated from server 120 to UD 110, and the like, as well as combinations thereof).

In one embodiment, the service propagation channel 150 is established such that it does not traverse SDCF 130 (not illustrated in FIG. 1), in which case SDCF 130 may provide indirect control over delivery of services from server 120 to UD 110. In this embodiment, for example, SDCF 130 may provide indirect control over delivery of services from server 120 to UD 110 by signaling any device(s) associated with delivery of the service from server 120 to UD 110. For example, SDCF 130 may provide indirect control over delivery of services from server 120 to UD 110 by signaling server 120 with control information for controlling one or more characteristics of delivery of the service from server 120 to UD 110 via service propagation channel 150 (illustratively, using the service control signaling channel 145 depicted in FIG. 1), by signaling one or more other network elements traversed by service propagation channel 150 for controlling one or more characteristics of delivery of the service from the other network element(s) to UD 110 via service propagation channel 150 (note that the other network element(s) is omitted from FIG. 1 for purposes of clarity and, therefore, any associated control channel(s) is not illustrated in FIG. 1), and the like, as well as combinations thereof. It will be appreciated that combinations of such service delivery control techniques may be used in any suitable manner (e.g., for a single service session to a UD, for different service sessions to a UD, for different service sessions to different UDs, and the like).

Thus, given that SDCF 130 may control delivery of services from servers to user devices in a number of ways, SDCF 130 may be deployed within communication system 100 in a number of ways.

In one embodiment, for example, in which the SDCF capability is deployed within an CDMA2000 network, the SDCF 130 may be deployed on the Base Transceiver Stations (BTSs), the Radio Network Controller (RNC), as a standalone component within the Radio Access Network (RAN) portion of the network (illustratively, within AN 102), as a standalone component within the core network (illustratively, within CN 104), as a part of server 120, and the like, or even as a combination thereof where the functionally is deployed within the network in a redundant fashion and/or where the functionality is distributed across elements of the network.

In one embodiment, for example, in which the SDCF capability is deployed within a UMTS network, the SDCF 130 may be deployed on the Serving GPRS Support Node (SGSN), on the GPRS Gateway Support Node (GGSN as a standalone component within the Radio Access Network (RAN) portion of the network (illustratively, within AN 102), as a standalone component within the core network (illustratively, within CN 104), as a part of server 120, and the like, or even as a combination thereof where the functionally is deployed within the network in a redundant fashion and/or where the functionality is distributed across elements of the network.

In one embodiment, for example, in which the SDCF capability is deployed within an LTE network, the SDCF 130 may be deployed on the PDN Gateway (PGW), the Serving Gateway (SGW), as a standalone component within the LTE radio access network, as a standalone component within the EPC network supporting the LTE radio access network, as a part of server 120, and the like, or even as a combination thereof where the functionally is deployed within the network in a redundant fashion and/or where the functionality is distributed across elements of the network.

From the foregoing examples, it will be appreciated that the SDCF 130 may be deployed in a centralized or distributed fashion at any location(s) within the network (e.g., within the RAN portion of a wireless network that is divided into RAN and CORE portions, within the CORE portion of a wireless network that is divided into RAN and CORE portions, at any suitable location within wireless networks implemented using a flat network architecture, at any suitable locations within wireline networks, and the like).

Although primarily depicted and described with respect to use of SDCF 130 to control delivery of services from a single server to a single user device, SDCF 130 may be used to control delivery of services from any number of servers to any number of user devices (e.g., for controlling delivery of services from multiple servers to one user device, for controlling delivery of services from one server to multiple user device, for controlling delivery of services from multiple servers to multiple user devices, and the like). Thus, it will be appreciated that the communication system 100 of FIG. 1 is provided merely for purposes of clarity in describing the service delivery control capability and, therefore, that the service delivery control capability is not limited to such an implementation.

FIG. 2 depicts one embodiment of a method for controlling delivery of services from a server to a user device. The method 200 of FIG. 2 describes steps performed by a service delivery control function for controlling delivery of services from a server to a user device.

At step 202, method 200 begins.

At step 204, service delivery feedback information is received from the user device.

The service delivery feedback information may include any information suitable for use by the service delivery control function to control delivery of services provided from the server to the user device, which, as indicated herein, may depend on factors such as the type of service being provided, the type of user device from which the service delivery feedback information is received, user preferences of one or more users of the user device, and the like, as well as combinations thereof.

In one embodiment, service delivery feedback information includes at least one of user device state information, user activity information, and the like, as well as combinations thereof. In one such embodiment, the service delivery feedback information includes both user device state information and user activity information. The service delivery feedback information also may include other types of information.

The user device state information may include any information indicative of the state of the user device. For example, the user device state information may include one or more of the following types of information: user device power state information, user device processor state information, user device memory state information, user device battery state information, user device wireless channel quality information, and the like, as well as combinations thereof.

The user device power state information provides an indication of a power state of the user device, such as whether the user device is dormant or active, whether the user device is dormant but expected to become active, whether the user device is active but expected to become dormant, and like information associated with the power state of the user device.

The user device processor state information provides an indication of the state of the processor on the user device. For example, user device processor state information may provide an indication as to an amount of processor capability that is available for use on the user device, an amount of processor capability that is being utilized on the user device (e.g., processor occupancy), and the like, as well as combinations thereof.

The user device memory state information provides an indication of the occupancy of the memory on the user device (e.g., for one or more of main memory, cache memory, buffers, and the like). For example, user device memory state information may provide indications as to how much available memory is available on the user device, how much memory has already been consumed on the user device, and the like, as well as combinations thereof. For example, user device memory state information may provide indications as to whether one or more buffers on the user device are nearing overflow. The user device memory state information may include any other information associated with permanent or temporary storage of information on the user device.

The user device battery state information provides an indication of the amount of battery power available at the user device and, optionally, may provide an indication as to whether the user device currently is plugged in or is operating on battery power.

The user device wireless channel quality information provides an indication of the quality of the wireless channel available to the user device. The user device wireless channel quality information may include one or more of signal strength information indicative of a signal strength available to the user device, RLC layer retransmission information indicative of the level of RLC layer retransmissions at the user device, radio resource management state information, and like information suitable for providing an indication of the quality of the wireless channel available to the user device, as well as combinations thereof.

The user activity information may include any information indicative of the user activity on the user device. For example, the user activity information may include one or more of the following types of information: off-line user activity information, on-line user activity information, and the like, as well as combinations thereof.

The off-line user activity information provides an indication of activity by a user or users of the user device for actions performed locally at the user device without using any connections to the network. The off-line user activity information may provide indications as to the amount of user activity, the type(s) of user activity, and the like, as well as combinations thereof. For example, the off-line user activity information may provide indications such as: that the user is playing music on the user device, that the user is playing a game on the user device, that the user is currently running X number of local programs on the user device, and the like, as well as combinations thereof. The off-line user activity information may be determined by the user device in any suitable manner, e.g., by monitoring programs running locally on the user device, monitoring user interactions with one or more user interfaces of the user device, and the like, as well as combinations thereof.

The on-line user activity information provides an indication of activity by a user or users of the user device for actions performed at the user device using one or more connections between the user device and the network. The on-line user activity information may provide indications as to the amount of user activity, the type(s) of user activity, and the like, as well as combinations thereof. For example, the on-line user activity information may provide one or more of an indication of a number of outgoing traffic streams being transmitted from the user device, a number of incoming traffic streams being received at the user device, the types of content being conveyed by traffic streams active at the user device, the rates of traffic streams active at the user device, and the like, as well as combinations thereof.

The service delivery feedback information may include any other information suitable for use in controlling delivery of services from the server to the user device.

At step 206, service delivery feedback information is processed for detecting conditions on the user device.

The processing of the service delivery feedback information for detecting conditions on the user device may be performed in any suitable manner, e.g., identifying values of the service delivery feedback information, comparing values of the service delivery feedback information to associated thresholds, and the like, as well as combinations thereof.

The processing of the service delivery feedback information for detecting conditions on the user device may be performed for any suitable number and types of conditions, which may depend on one or more of the types of service delivery feedback information received, the type of service to be provided, and the like, as well as combinations thereof.

The condition or conditions evaluated by processing the service delivery feedback information may include one or more of: a user device power state condition, a user device processor state condition, a user device memory state condition, a user device battery state condition, a user device channel quality condition, and a user activity condition, each of which is described in additional detail below.

A first condition which may be detected is a user device power state condition. In one embodiment, the user device power state condition may be detected using a user device power state value (determined from the service delivery feedback information). In one embodiment, two user device power states may be supported, e.g., active and dormant. In this embodiment, a user device power state value indicative that the user device is dormant may be identified as satisfying a user device power state condition (e.g., such that one or more services may be prevented or delayed from being provided to the user device while the user device is unable to receive the service(s)). In this embodiment, a user device power state value indicative that the user device is active may be identified as satisfying the user device power state condition (e.g., such that one or more services may be provided to the user device while the user device is able to receive the service(s)). In other embodiments, additional user device power state conditions may be supported. This condition is useful for improving the QoE for the user, such as by controlling the timing of services being provided to the user (e.g., such that the user does not miss any services while the user device is dormant, such that content may be provided to the user device while dormant for later viewing when the user device is active, and the like).

A second condition which may be detected is a user device processor state condition. In one embodiment, a user device processor state condition may be detected using a processor occupancy value (determined from the user device processor state information) and one or more associated processor occupancy thresholds. In one such embodiment, for example, in which one processor occupancy threshold is used, a processor occupancy below the processor occupancy threshold may be identified as satisfying a condition (e.g., where a service should be provided to the user device while the processor is available for performing any processing required for the service, such that a higher coding rate may be used for content being provided to the user device, and the like) or a processor occupancy above the processor occupancy threshold may be identified as satisfying a condition (e.g., where a service should be prevented or delayed from being provided to the user device while the processor is not available for performing any processing required for the service, such that a lower coding rate may be used for content being provided to the user device, and the like). This condition is useful for improving the QoE for the user, such as by controlling the manner in which any remaining available processor capability of the user device is used.

A third condition which may be detected is a user device memory state condition. In one embodiment, a user device memory state condition may be detected using a memory occupancy value (determined from the user device memory state information) and one or more associated memory occupancy thresholds. In one such embodiment, for example, in which one memory occupancy threshold is used, a memory occupancy below the memory occupancy threshold may be identified as satisfying a condition (e.g., where a service should be provided to the user device while there is memory available for the service, such that a higher coding rate may be used for content being provided to the user device, and the like) or a memory occupancy above the memory occupancy threshold may be identified as satisfying a condition (e.g., where a service should be prevented or delayed from being provided to the user device where there is insufficient memory available at the user device for the service, such that a lower coding rate may be used for content being provided to the user device, and the like). As described herein, the user device memory state condition may be based on one or more types of memory of the user device (e.g., flash memory, cache memory, buffers, and the like), which may be tracked together and/or individually (e.g., as one or more separate memory conditions associated with different types of memory of the user device) This condition is useful for improving the QoE for the user, such as by controlling the manner in which any remaining available memory of the user device is used.

A fourth condition which may be detected is a user device battery state condition. In one embodiment, a user device battery state condition may be detected using a battery power status value (determined from the user device battery state information) and one or more associated battery power thresholds. In one such embodiment, for example, in which one battery power threshold is used, a battery power status value above the battery power threshold may be identified as satisfying a condition (e.g., where a service should be provided to the user device while there is sufficient battery power at the user device for performing any processing required for the service, such that a higher coding rate may be used for content being provided to the user device, and the like) or a battery power status value below the battery power threshold may be identified as satisfying a condition (e.g., where a service should be prevented or delayed from being provided to the user device while there is insufficient battery power at the user device for performing any processing required for the service, such that a lower coding rate may be used for content being provided to the user device, and the like). This condition is useful for improving the QoE for the user, such as by controlling the manner in which any remaining battery power is used, such that use of the battery power of the user terminal may be prioritized.

A fifth condition which may be detected is a user device channel quality condition. In one embodiment, a user device channel quality condition may be detected using a signal strength value (determined from the user device wireless channel quality information) and one or more associated signal strength thresholds. In one such embodiment, for example, in which one signal strength threshold is used, a signal strength value above the signal strength threshold may be identified as satisfying a condition (e.g., where a service should be provided to the user device while the signal strength of the user device is sufficient for enabling the user device to receive the service, such that a higher coding rate may be used for content being provided to the user device, and the like) or a signal strength status value below the signal strength threshold may be identified as satisfying a condition (e.g., where a service should be prevented or delayed from being provided to the user device while the signal strength of the user device is insufficient for enabling the user device to receive the service, such that a lower coding rate may be used for content being provided to the user device, and the like). In one embodiment, the user device channel quality condition may be detected using information indicative of a number of Radio Link Control (RLC) protocol retransmissions (determined from the user device wireless channel quality information) and one or more associated retransmission thresholds. In one embodiment, a combination of such information may be used for detecting a user device channel quality condition. This condition is useful for improving the QoE for the user, such as by controlling the manner in which any remaining battery power is used (e.g., preventing battery drain when services are provided over poor channels and the like).

A sixth condition which may be detected is a user activity condition. In one embodiment, a user activity condition may be detected using a user activity value that is indicative of a level of user activity on the user device (determined from the user activity information) and one or more associated user activity thresholds. In one such embodiment, the user activity value may be computed using user activity information, e.g., using one or more of off-line user activity information (e.g., a number of programs active on the user device, information indicative of the type(s) of program(s) active on the user device, and the like), on-line user activity information (e.g., a number of active traffic flows to/from the user device, information indicative of the type(s) of content being propagated by the traffic flow(s), and the like), and the like, as well as combinations thereof. In one such embodiment, for example, in which one user activity threshold is used, a user activity value below the user activity threshold may be identified as satisfying a condition (e.g., where a service should be provided to the user device while user activity at the user device is relatively low) or a user activity value above the user activity threshold may be identified as satisfying a condition (e.g., where a service should be prevented or delayed from being provided to the user device while user activity at the user device is relatively high). This condition is useful for improving the QoE for the user, such as by controlling the usage of resources at the user device. In one embodiment, off-line user activity and on-line user activity may be monitored/detected as separate conditions.

Although primarily described with respect to embodiments in which the conditions are detected by identifying condition values and/or by comparing a condition value to a single condition threshold, each of the conditions may be detected in any suitable manner, which may depend, at least in part, on the type of conditions being monitored for and detected.

Although primarily described with respect to embodiments in which monitoring for the conditions is performed relatively statically (e.g., where, for a given condition, the same condition threshold(s), or other standard(s) by which the given condition is monitored, is used in all situations), in other embodiments monitoring for at least a portion of the conditions may be performed more dynamically. In this embodiment, requirement(s) according to which monitoring of a condition is performed (i.e., standard(s) by which the determination as to whether a condition is satisfied is made, e.g., using a specific value(s), threshold(s), and the like) may vary dynamically. For example, the standard(s) according to which monitoring for a condition is performed may vary dynamically depending on one or more factors, such as underlying network technology, results from evaluation of other conditions, and the like, as well as various combinations thereof.

Although primarily described herein with respect to specific conditions associated with a user device, it will be appreciated that monitoring may be performed for detecting fewer or more conditions which may be utilized for determining initiation of control actions for controlling delivery of services to the user device.

Although primarily described with respect to embodiments in which processing of service delivery feedback information, for determining initiation of control actions for controlling services, is performed by monitoring for conditions, it will be appreciated that processing of service delivery feedback information for determining initiation of control actions for controlling services may be performed in any other suitable manner.

At step 208, a determination is made as to whether a control action is to be initiated for controlling delivery of a service to the user device.

The determination as to whether a control action is to be initiated for controlling delivery of a service to the user device may be performed in any suitable manner, which may depend on the conditions for which monitoring is performed, the numbers/types of conditions which must be satisfied, and the like (each of which may depend on factors such as the type of service to be provided, the user device, and the like, as well as combinations thereof).

In one embodiment, the determination as to whether a control action is to be initiated is based on monitoring for one or more conditions.

In one embodiment, the service delivery control function may be arranged such that the condition(s) that must be satisfied before a control action is initiated may be configured in any suitable manner.

In one embodiment, any suitable number(s) and type(s) of conditions must be satisfied before a control action is initiated.

In one embodiment, the condition(s) for which monitoring is performed may be set on or more of a per-UD basis, a per-service-type basis, a per-service basis, and a per-service-session basis. For example, where the condition(s) for which monitoring is performed is/are set on a per-UD basis, the condition(s) for which monitoring is performed may be (but are not necessarily required to be) different for different services available to and/or being provided to the UD. For example, where the condition(s) for which monitoring is performed is/are set on a per-service-type basis, the condition(s) for which monitoring is performed may be (but are not necessarily required to be) different for streaming video service, content push service, automatic backup service, and other services). For example, where the condition(s) for which monitoring is performed is/are set on a per-service basis, the condition(s) for which monitoring is performed may be (but are not necessarily required to be) different for a first streaming video service and a second streaming video service, different for a first automatic backup service and a second automatic backup service, so forth. For example, where the condition(s) for which monitoring is performed is/are set on a per-service basis, the condition(s) for which monitoring is performed may be (but are not necessarily required to be) different for a first session of a first video streaming service and a second session of the first video streaming service, different for first session of a second video streaming service and a second session of the second video streaming service, and so forth. A combination of such configuration types may be used.

In one embodiment, the condition or conditions that must be satisfied before a control action is initiated may be set on one or more of a per-service-type basis, a per-service basis, and a per-service-session basis. In each of these cases, one or more of the following requirements may be specified as requirements for initiating a control action: only one of a plurality of conditions for which monitoring is performed needs to be satisfied in order for a control action to be initiated, multiple but not all of the plurality of conditions for which monitoring is performed need to be satisfied in order for a control action to be initiated, all of the plurality of conditions for which monitoring is performed need to be satisfied in order for a control action to be initiated.

In one embodiment, in which multiple conditions are monitored for determining if/when any control action(s) is to be initiated, it may be possible that satisfaction of different conditions may indicate that different, and possibly contradictory, control actions should be performed. In this embodiment, the determination as to whether a control action is initiated, or which of multiple control actions is to be initiated, may be performed in any suitable manner. For example, different conditions for which monitoring is performed may be prioritized for use in selecting between contradictory control actions, a score may be computed for the contradictory control actions (e.g., based on the number of conditions satisfied, weighting of the importance of conditions satisfied, and the like), and the like, as well as combinations thereof.

The service delivery control function may be configured in any other manner suitable for determining, on the basis of service delivery feedback information, whether a control action is to be initiated for controlling delivery of the service to the user device.

If a control action is not to be initiated, method 200 returns to step 204, such that additional service delivery feedback information may be received and processed for determining when to initiate a control action for controlling delivery of service to the user device.

If a control action is to be initiated, method 200 proceeds to step 210, such that a control action may be initiated for controlling delivery of the service to the user device.

At step 210, a control action is initiated for controlling delivery of the service to the user device.

The control action may be initiated for controlling one or more characteristics of service delivery, such as: a timing of delivery of the service to the UD; selection of services, service features, and/or content to be delivered to the UD; one or more rates associated with delivery of the service to the UD (e.g., coding rate, transport rate, and the like); adaptation of services, service features, and/or content to be delivered to the UD; and the like, as well as combinations thereof.

In one embodiment, for example, controlling the timing of delivery may include one or more of controlling the time at which the service is initiated (e.g., initiating a service that is not scheduled to be initiated at that time, postponing initiation of a pre-scheduled service, and the like), suspending a service (and, optionally, re-starting the service at a later time), terminating a service, and the like.

In one embodiment, for example, controlling the selection of services, service features, and/or content may include making some content available while excluding other content, controlling one or more service aspects of the service (e.g., such as whether a file attachment will be sent as part of service delivery and any other suitable service aspects, which may vary for different types of services), and the like, as well combinations thereof.

In one embodiment, for example, controlling one or more rates associated with delivery of the service may include controlling one or more of the coding rate of the content, the transport rate of the content (e.g., download rate, streaming video transport rate, and the like), and the like, as well as combinations thereof. The controlling of one or more rates may include controlling selection of one or more rates to be used, controlling adaptation of one or more rates, and the like, as well as combinations thereof.

In one embodiment, for example, controlling adaptation of services, service features, and/or content may include removing portions of services, service features, and/or content being provided, modifying portions of services, service features, and/or content being provided, adding new services, service features, and/or content to the services, service features, and/or content being provided, and the like, as well as combinations thereof.

The control action may control any other suitable characteristic(s) of delivery of the service from the server to the user device.

The control action may be initiated in any suitable manner, which may depend on the implementation of the service delivery control function within the network, the type of service to be provided, and the like, as well as combinations thereof. For example, initiation of the control action may include one or more of (1) initiating one or more actions locally at the service delivery control function (e.g., initiating, suspending, resuming, and/or terminating providing of content to the user device, initiating a change to a coding rate for coding of content being provided to the user device, and the like); (2) initiating signaling to one or more remote systems remote to the system(s) on which the service delivery control function is implemented (e.g., signaling a content server to initiate, suspend, resume, or terminate providing of content to the user device, signaling a network device traversed by content being provided to the user device to change the coding rate for the content being provided to the user device, and the like).

As depicted in FIG. 2, from step 210, method 200 returns to step 204, such that additional service delivery feedback information may be received and processed for determining when to initiate a control action for controlling delivery of service to the user device.

It will be appreciated that method 200 may be invoked and terminated at any suitable time. For example, method 200 may be invoked when the service delivery control function detects the presence of the user device and a feedback signaling channel is established therebetween, when a service is due to be provided to the user device, and the like. For example, method 200 may be terminated when a service that was being provided to the user device is complete, where the service delivery control function detects that there is no longer an active feedback signaling channel with the user device, and the like.

Although primarily described with respect to embodiments in which the monitoring is performed for detecting conditions for a single service (for purposes of clarity), it will be appreciated that method 200 may be invoked in any manner suitable for supporting multiple services (e.g., services available to the user device but not currently active for the user device, services currently active for the user device, and the like, as well as combinations thereof). In one embodiment, for example, method 200 may be invoked multiple times for multiple different services available to and/or being used by the user device. In one embodiment, for example, method 200 may be adapted such that the steps are performed for multiple services together (e.g., the received service delivery feedback information may be applicable to any services available to and/or currently being used by the user device, the processing of the service delivery feedback information may be performed in a manner for detecting any conditions and/or combinations of conditions which may indicate that an associated control action or control actions should be initiated for one or more services available to the user device and/or currently being used by the user device, the determination as to whether a control action or control actions should be initiated may be performed for one or more services available to the user device and/or currently being used by the user device, and one or more control actions may be initiated for controlling delivery of one or more services to the user device). In this manner, although depicted and described serially, it will be appreciated that the steps of method 200 may be performed contemporaneously (e.g., service delivery feedback information may continue to be received and processed contemporaneously with evaluation of control actions for initiation based on previously received service delivery feedback information).

The operation of method 200 of FIG. 2 in providing service delivery control may be better understood by considering the following exemplary uses of the service delivery control capability.

As a first example, assume that a content server is storing content that needs to be pushed to the user device. The service delivery control function receives service delivery feedback information from the user device. The service delivery control function is configured to push the content only when a certain set of conditions are identified, on the basis of the service delivery feedback information, as being satisfied. In this example, assume that before the content is pushed to the user device, each of the following conditions must be satisfied: (1) there is no off-line user activity; (2) there is no on-line user activity; (3) the user device processor occupancy is below a threshold; (4) the user device battery power is above a threshold (or the user device is plugged into a charger); (5) the user device is in a connected state and either dormant or scheduled to become dormant in the near future; and (6) the user device signal strength is above a threshold. This combination of conditions will ensure that the content is only pushed to the user device at a time at which the QoE of the user will not be impacted and the resources of the user device that are consumed to receive the pushed content are not unacceptable. It will be appreciated that although described with respect to an example in which each of these conditions must be satisfied, the service delivery control function may be arranged such that any suitable condition or combination of conditions must be satisfied before the content is pushed to the user device.

As a second example, assume that a content server is streaming video to the user device. The service delivery control function receives service delivery feedback information from the user device as the video is streamed to the user device. The service delivery control function is configured to adapt the coding rate of the video stream based on the condition of the user device, as determined based on the service delivery feedback information. In this example, the coding rate is decreased if any one or more of the following conditions is satisfied: (1) the user device battery power is below a threshold, (2) the user device processor occupancy is above a threshold; (3) the user device signal strength is below a threshold; (4) the user device buffers are nearing overflow; and (5) the RLC layer retransmissions from the user device are above a threshold. Similarly, in this example, the coding rate is increased if any one or more of the following conditions is satisfied: (1) the user device battery power is above a threshold or the user device is plugged into a power supply, (2) the user device processor occupancy is below a threshold; (3) the user device signal strength is above a threshold; (4) the user device buffers are not nearing overflow; and (5) the RLC layer retransmissions from the user device are below a threshold. This combination of conditions will ensure that the video is streamed to the user device with the highest possible quality level suitable for the condition of the user device. In this example, as well as in other situations, it may be necessary to prioritize the conditions for which monitoring is performed, such that if conflicting conditions are identified as being satisfied (e.g., where the user device processor occupancy is above a threshold such that the coding rate should be decreased, while at the same time the user device batter power is above a threshold such that the coding rate should be increased), the conflicts can be resolved in a manner enabling suitable control over streaming of the video to the user device). It will be appreciated that although described with respect to an example in which coding rate may be decreased and increased based on each of a plurality of individual conditions, the service delivery control function may be arranged such that suitable combinations of conditions must be satisfied before the coding rate of content is adapted.

As a third example, assume that a server provides an automatic backup service for the user device, for backing up data stored on the user device. The service delivery control function receives service delivery feedback information from the user device. The service delivery control function is configured to start the automatic backup service only when a certain set of conditions is identified, on the basis of the service delivery feedback information, as being satisfied. In this example, assume that before the automatic backup service is provided, the following two conditions must be satisfied: (1) there is no off-line user activity and (2) there is no on-line user activity; and, further, at least two of the following three conditions must be satisfied: (1) the user device processor occupancy is below a threshold, (2) the user device battery power is above a threshold (or the user device is plugged into a charger); and (3) the user device signal strength is above a threshold. This combination of conditions will ensure that the automatic backup service is only performed at a time at which the QoE of the user will not be impacted and the resources of the user device that are consumed to provide the data to the server for backup are not unacceptable. It will be appreciated that although described with respect to an example in which a certain combination of conditions must be satisfied, the service delivery control function may be arranged such that any suitable condition or combination of conditions must be satisfied before the automatic backup service is initiated.

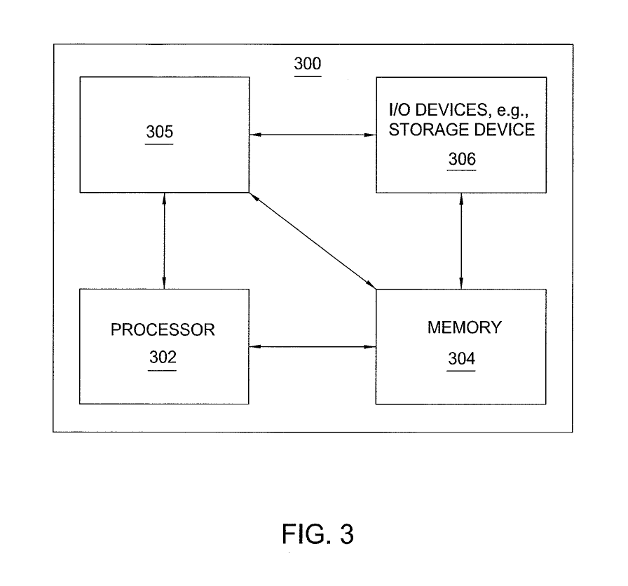

FIG. 3 depicts a high-level block diagram of a computer suitable for use in performing the functions described herein. As depicted in FIG. 3, computer 300 includes a processor element 302 (e.g., a central processing unit (CPU) and/or other suitable processor(s)), a memory 304 (e.g., random access memory (RAM), read only memory (ROM), and the like), a service delivery feedback/control module/process 305, and various input/output devices 306 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that computer 300 is suitable for use as UD 110 and/or for use within UD 110 for purposes of providing service delivery feedback to SDCF 130, and also is suitable for use as SDCF 130 and/or for use within SDCF 130 for providing the service delivery control functions on the basis of service delivery feedback information that is received from UD 110.

It will be appreciated that functions depicted and described herein may be implemented in software and/or in a combination of software and hardware, e.g., using a general purpose computer, one or more application specific integrated circuits (ASIC), and/or any other hardware equivalents. In one embodiment, a service delivery feedback/control process 305 can be loaded into memory 304 and executed by processor 302 to implement the functions as discussed herein above. Thus, service delivery feedback/control process 305 (including associated data structures) can be stored on a computer readable storage medium, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for controlling delivery of services from a server to a user device using a service delivery control function, the method comprising:
receiving, at the service delivery control function, service delivery feedback information comprising user device state information associated with the user device and user activity information indicative of activity of a user using the user device; and
initiating, by the service delivery control function based on at least a portion of the service delivery feedback information, a control action adapted for controlling at least one characteristic of delivery of the service from the server to the user device.

2. The method of claim 1, wherein the user device state information comprises at least one of:
user device power state information of the user device;
user device processor state information of the user device;
user device memory state information of the user device;
user device battery state information of the user device;
signal strength information of the user device; and
channel condition information of the user device.

3. The method of claim 1, wherein the user activity information comprises at least one of:
information indicative of off-line activity of a user of the user device; and
information indicative of on-line activity of a user of the user device.

4. The method of claim 3, wherein the information indicative of off-line activity of a user of the user device comprises at least one of:
information indicative of a number of programs being executed locally on the user device; and
information indicative of interaction by the user with at least one user interface of the user device.

5. The method of claim 3, wherein the information indicative of on-line activity of a user of the user device comprises information indicative of a number of active traffic flows associated with the user device.

6. The method of claim 1, wherein the control action is initiated in response to a determination that at least one condition associated with the user device is satisfied.

7. The method of claim 1, further comprising:
monitoring, by the service delivery control function using the service delivery feedback information, for a plurality of conditions associated with the user device; and
initiating the control action in response to an indication that at least one of the conditions for which monitoring is performed is satisfied.

8. The method of claim 7, wherein the control action is initiated only in response to a determination that all of the conditions for which monitoring is performed are satisfied.

9. The method of claim 7, wherein the conditions for which monitoring is performed depend on the service.

10. The method of claim 7, wherein the conditions for which monitoring is performed comprise at least one of:
an indication of the user device being in a particular power state;
a user device processor availability or occupancy satisfying a threshold;
a user device memory availability or occupancy satisfying a threshold;
a user device battery power satisfying a threshold;
an indication of the user device being plugged into a charger;
a user device signal strength satisfying a threshold;
a user device channel quality satisfying a threshold; and
a user activity level satisfying a threshold.

11. The method of claim 1, wherein controlling the at least one characteristic of delivery of the service from the server to the user device comprises at least one of:
controlling a timing with which the service is provided to the user device;
controlling selection of at least one of a service feature to be provided to the user device and content to be provided to the user device;
controlling at least one rate associated with delivery of the service to the user device; and
controlling selection of at least one of a service feature to be provided to the user device and content to be provided to the user device.

12. The method of claim 1, wherein the at least one characteristic of delivery of the service from the server to the user device comprises a timing with which the service is provided to the user device.

13. The method of claim 12, wherein controlling a timing with which the service is provided to the user device comprises at least one of initiating delivery of the service, suspending delivery of the service, re-starting delivery of the service, and terminating delivery of the service.

14. The method of claim 12, wherein controlling a timing with which the service is provided to the user device comprises controlling execution of the service for the user device when the service delivery feedback information indicates that a level of user activity on the user device satisfies a threshold.

15. The method of claim 1, wherein the at least one characteristic of delivery of the service from the server to the user device comprises a coding rate of content being provided to the user device.

16. The method of claim 15, wherein controlling the coding rate of content being provided to the user device comprises changing the coding rate in response to a determination that at least one condition is satisfied;
wherein the at least one condition comprises at least one of a determination that a processor occupancy of a processor of the user device satisfies a threshold, a determination that a battery level of a battery of the user device satisfies a threshold, a determination that a buffer occupancy of the user device satisfies a threshold, a determination that an channel quality of the user device satisfies a threshold.

17. The method of claim 1, wherein the service delivery control function is running a service delivery control application, wherein the service delivery feedback information is received via an application layer signaling channel between the service delivery control function and the user device.

18. The method of claim 1, wherein initiating the control action comprises initiating a control signal toward at least one network element associated with delivery of the service from the server to the user device.

19. An apparatus for controlling delivery of services from a server to a user device using a service delivery control function, comprising:
means for receiving, at the service delivery control function, service delivery feedback information comprising user device state information associated with the user device and user activity information indicative of activity of a user using the user device; and
means for initiating, by the service delivery control function based on at least a portion of the service delivery feedback information, a control action adapted for controlling at least one characteristic of delivery of the service from the server to the user device.

20. A computer readable storage medium storing instructions which, when executed by a processor, cause the processor to perform a method for controlling delivery of services from a server to a user device using a service delivery control function, the method comprising:
receiving, at the service delivery control function, service delivery feedback information comprising user device state information associated with the user device and user activity information indicative of activity of a user using the user device; and
initiating, by the service delivery control function based on at least a portion of the service delivery feedback information, a control action adapted for controlling at least one characteristic of delivery of the service from the server to the user device.
